(19) United States
(12) Patent Application Publication
(10) Pub. No.: US 2025/0106947 A1
(43) Pub. Date: Mar. 27, 2025

(54) HEATING DEVICE AND IMAGE FORMING APPARATUS

(71) Applicant: FUJIFILM Business Innovation Corp., Tokyo (JP)

(72) Inventors: Shingo AKIYAMA, Kanagawa (JP); Shogo Kamiya, Kanagawa (JP); Kotaro Araki, Kanagawa (JP)

(73) Assignee: FUJIFILM Business Innovation Corp., Tokyo (JP)

(21) Appl. No.: 18/598,935

(22) Filed: Mar. 7, 2024

(30) Foreign Application Priority Data
Sep. 26, 2023 (JP) 2023-163629

(51) Int. Cl. H05B 3/00; B41J 11/00; H05B 3/02

(52) U.S. Cl. CPC H05B 3/0066; B41J 11/0021; H05B 3/02; H05B 2203/016

(57) ABSTRACT

A heating device includes a resistance heating element that includes an electrode portion to which electric power is supplied and is rotatable, a connector that is attached to the resistance heating element, includes a contact terminal rotatable together with the resistance heating element, and supplies electric power to the resistance heating element through the contact terminal, and a pressing structure that presses the contact terminal against the electrode portion after the connector is attached to the resistance heating element.

### CROSS-REFERENCE TO RELATED APPLICATIONS

This application is based on and claims priority under 35 USC 119 from Japanese Patent Application No. 2023-163629 filed Sep. 26, 2023.

### BACKGROUND

### (i) Technical Field

The present disclosure relates to a heating device and an image forming apparatus.

### (ii) Related Art

Japanese Unexamined Patent Application Publication No. 2013-235223 discloses the heating device in which the contact terminal includes a contact portion in contact with an electrode of the heater and a hook-shaped portion provided in a region on the downstream of the contact portion in a heater entering direction. This avoids a phenomenon in which the contact portion of the contact terminal protruding into the opening of the connector comes into contact with a member inserted in the opening and is worn, and suppresses conduction failure.

Japanese Unexamined Patent Application Publication No. 2001-22212 discloses an image forming apparatus that includes a fixing device using a rotatably driven heating and fixing roller, in which the heating and fixing roller has an electrode member that energizes a resistance heating element, and the electrode member is brought into contact with the resistance heating element at three or more contact points, so that conduction between the resistance heating element and the electrode member can be stably achieved.

### SUMMARY

For example, a heating device such as a fixing device used in an image forming apparatus may use a resistance heating element for heating. The heating device using the resistance heating element includes a connector for supplying electric power, and the resistance heating element includes an electrode portion electrically connected to the connector. The connector and the electrode portion of the resistance heating element are electrically connected to each other by a contact terminal.

Here, when a connector is connected to supply electric power to the resistance heating element, the resistance heating element may be damaged by the contact terminal, resulting in conduction failure. In order to prevent this conduction failure, the above-described Japanese Unexamined Patent Application Publication No. 2013-235223 proposes a configuration in which, in a non-rotating resistance heating element, the contact terminal is separated from the resistance heating element when the connector is connected, and the contact terminal is moved and pressed from the outside after the connector is connected. However, in a rotating resistance heating element, when the resistance heating element and the connector described in Japanese Unexamined Patent Application Publication No. 2013-235223 are rotated together, the lead wire connected to the connector is entangled. Thus, this configuration cannot be adopted as it is. Further, in a case where the configuration as described in Japanese Unexamined Patent Application Publication No. 2013-235223 is adopted as it is, and a contact terminal whose position is fixed is brought into contact with a rotating resistance heating element, the pressures of the contact terminal may not be kept constant due to micro irregularities occurred on the surface of the resistance heating element, thus resulting in conduction failure.

Aspects of non-limiting embodiments of the present disclosure relate to preventing, in a rotating resistance heating element, conduction failure due to a damage of the resistance heating element when a connector is attached or detached, and suppressing conduction failure when the resistance heating element is rotated.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a heating device including a resistance heating element that includes an electrode portion to which electric power is supplied and is rotatable, a connector that is attached to the resistance heating element, includes a contact terminal rotatable together with the resistance heating element, and supplies electric power to the resistance heating element through the contact terminal, and a pressing structure that presses the contact terminal against the electrode portion after the connector is attached to the resistance heating element.

### BRIEF DESCRIPTION OF THE DRAWINGS

An exemplary embodiment of the present disclosure will be described in detail based on the following figures, wherein:

FIG. 1 is a diagram for explaining an image forming apparatus according to the exemplary embodiment;

FIG. 2 is a diagram for explaining a fixing device according to the exemplary embodiment, and an enlarged view of the fixing device illustrated in FIG. 1;

FIG. 3 is a perspective view for explaining a resistance heating element according to the exemplary embodiment;

FIG. 4 is a diagram for explaining an electrode portion of the resistance heating element and a connector according to the exemplary embodiment, and is a cross section cut along IV-IV of FIG. 3;

FIGS. 5A to 5C are diagrams for explaining the contact of an outer cover with a contact terminal according to the exemplary embodiment, and are diagrams illustrating an upper part of the resistance heating element in FIG. 4; and

FIGS. 6A to 6C are diagrams illustrating a modification of the connector.

### DETAILED DESCRIPTION

Hereinafter, the exemplary embodiments will be described in detail with reference to the accompanying drawings.

### DESCRIPTION OF IMAGE FORMING APPARATUS

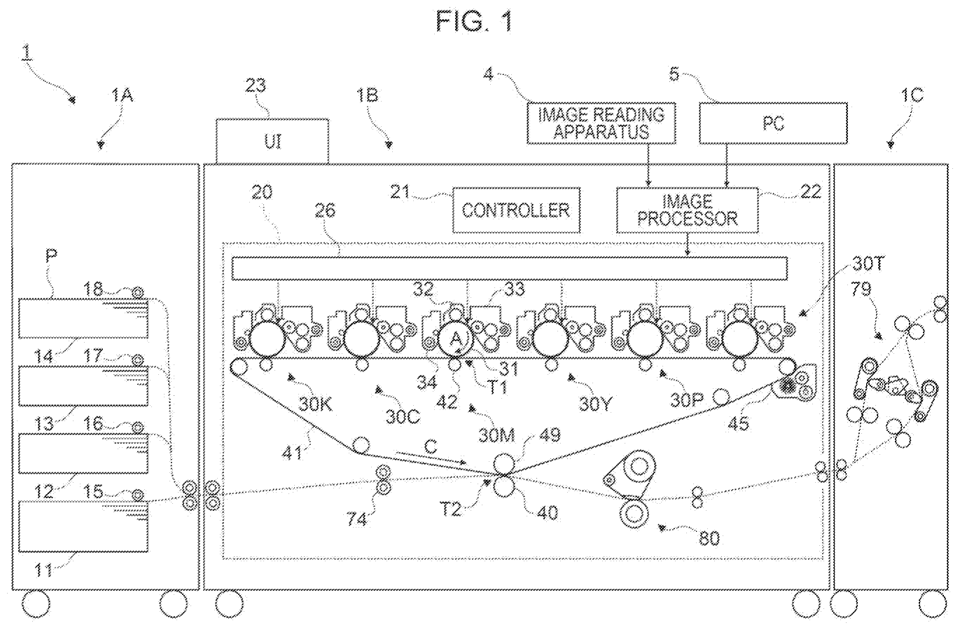

FIG. 1 is a diagram for explaining an image forming apparatus 1 according to the exemplary embodiment.

The image forming apparatus 1 according to the exemplary embodiment includes a paper feed unit 1A, a printing unit 1B, and a paper discharge unit 1C.

The paper feed unit 1A includes a first paper storage 11 to a fourth paper storage 14 that store paper P as an example of recording media.

The paper feed unit 1A also includes delivery rollers 15 to 18 that are provided corresponding to the first paper storage 11 to the fourth paper storage 14, respectively, and deliver the paper P stored in each paper storage to a transport path connected to the printing unit 1B.

The printing unit 1B includes an image forming part 20 that forms an image on the paper P. The printing unit 1B also includes a controller 21 that controls each part of the image forming apparatus 1.

Further, the printing unit 1B includes an image processor 22. The image processor 22 performs image processing on image data transmitted from an image reading apparatus 4 or a personal computer (PC) 5.

The printing unit 1B includes a user interface (UI) 23 that is formed by a touch panel and the like and notifies a user of information and receives an input of information from a user. The image forming part 20 includes six image forming units 30T, 30P, 30Y, 30M, 30C, and 30K (hereinafter, may be simply referred to as “image forming units 30”) arranged in parallel at regular intervals.

Each image forming unit 30 includes a photoreceptor drum 31 on which an electrostatic latent image is formed while rotating in the direction of arrow A, a charging roller 32 that charges the surface of the photoreceptor drum 31, a developing device 33 that develops an electrostatic latent image formed on the photoreceptor drum 31, and a drum cleaner 34 that removes toner and the like from the surface of the photoreceptor drum 31.

The image forming part 20 also includes an exposure device 26 that exposes the photoreceptor drum 31 of each image forming unit 30 to laser light.

Note that the exposure of the photoreceptor drum 31 by the exposure device 26 is not limited to the use of laser light. For example, a light source such as a light emitting diode (LED) may be provided for each image forming unit 30, so that the photoreceptor drum 31 may be exposed to light emitted from the light source.

Each image forming unit 30 has the same configuration except for a toner stored in the developing device 33. The image forming units 30Y, 30M, 30C, 30K form yellow (Y), magenta (M), cyan (C), and black (K) toner images, respectively.

The image forming units 30T and 30P form toner images using toners corresponding to corporate colors, foaming toners for Brailles, fluorescent color toners, toners for improving glossiness, and the like. In other words, the image forming units 30T and 30P form toner images using featured toners.

The image forming part 20 includes an intermediate transfer belt 41 to which the toner images in respective colors formed on the photoreceptor drums 31 of the image forming units 30 are transferred.

The image forming part 20 includes primary transfer rollers 42 that transfer the toner images in respective colors of the image forming units 30 to the intermediate transfer belt 41 at primary transfer sections T1.

The image forming part 20 also includes a secondary transfer roller 40 that transfers at once the toner images transferred onto the intermediate transfer belt 41 to the paper P at a secondary transfer section T2.

The image forming part 20 further includes a belt cleaner 45 that removes toner and the like from the surface of the intermediate transfer belt 41, and a fixing device 80 that fixes the secondary-transferred images on the paper P.

The image forming part 20 performs an image forming operation on the basis of a control signal from the controller 21.

To be specific, in the image forming part 20, the image data obtained by image processing performed by the image processor 22 on the image data input from the image reading apparatus 4 or the PC 5, is first supplied to the exposure device 26.

Then, in the image forming unit 30M for magenta (M), for example, the surface of the photoreceptor drum 31 is charged by the charging roller 32, and then the exposure device 26 irradiates the photoreceptor drum 31 with laser light modulated by the image data obtained from the image processor 22.

As a result, an electrostatic latent image is formed on the photoreceptor drum 31.

The formed electrostatic latent image is developed by the developing device 33, and a magenta toner image is formed on the photoreceptor drum 31.

Similarly, yellow, cyan, and black toner images are formed in the image forming units 30Y, 30C, and 30K, respectively, and toner images in featured colors are formed in the image forming units 30T and 30P.

The toner images in respective colors formed by the image forming units 30 are sequentially electrostatically transferred by the primary transfer rollers 42 onto the intermediate transfer belt 41 rotating in the direction of arrow C in FIG. 1, so that a superimposed toner image is formed on the intermediate transfer belt 41.

With the movement of the intermediate transfer belt 41, the superimposed toner image formed on the intermediate transfer belt 41 is transported to the secondary transfer section T2 formed by the secondary transfer roller 40 and a backup roller 49.

Meanwhile, the paper P is picked up from the first paper storage 11 by the delivery roller 15, for example, and then transported to the position of a registration roller 74 via the transport path.

Once the superimposed toner image is transported to the secondary transfer section T2, the paper P is supplied, at this timing, from the registration roller 74 to the secondary transfer section T2.

Then, in the secondary transfer section T2, the superimposed toner image is electrostatically transferred at once onto the paper P by the action of a transfer electric field formed between the secondary transfer roller 40 and the backup roller 49.

Thereafter, the paper P onto which the superimposed toner image is electrostatically transferred is transported to the fixing device 80.

The fixing device 80 performs processing of fixing the toner image on the paper P by pressurizing and heating the paper P on which the unfixed toner image is formed. The fixing device 80 is an example of a heating device.

Then, the paper P subjected to the fixing processing is transported to a paper stacking part (not illustrated) through a curl correcting section 79 provided in the paper discharge unit 1C.

### Description of Fixing Device 80

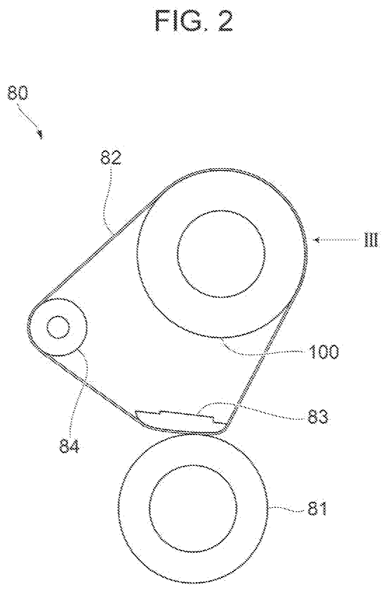

FIG. 2 is a diagram for explaining the fixing device 80 according to the exemplary embodiment, and an enlarged view of the fixing device 80 illustrated in FIG. 1. As illustrated in FIG. 2, the fixing device 80, which is one of the heating devices, includes a cylindrical pressure roller 81 that presses the paper P, a fixing belt 82 that pressurizes the pressure roller 81 and heats the paper P, a cylindrical resistance heating element 100 that heats the fixing belt 82, a fixing pad 83 that is disposed at a position facing the pressure roller 81 and presses the paper P together with the pressure roller 81, and a cylindrical steering roller 84 that is provided between the resistance heating element 100 and the fixing pad 83 and applies tension to the fixing belt 82. The pressure roller 81 is configured to be rotated by a motor (not illustrated), and with the rotation of the pressure roller 81, the fixing belt 82 is also rotated. The fixing belt 82 is stretched over the fixing pad 83, the steering roller 84, and the resistance heating element 100 with tension. Therefore, when the fixing belt 82 is rotated with the rotation of the pressure roller 81, the steering roller 84 and the resistance heating element 100 are rotated about their respective rotation axes.

In the exemplary embodiment, the fixing device 80 is configured to transport the paper P in a paper transport direction with the rotation of both the pressure roller 81 and the fixing belt 82. The fixing device 80 performs fixing processing by heating the paper P with the fixing belt 82 heated by the resistance heating element 100 and pressing the paper P with the fixing pad 83 and the pressure roller 81 while transporting the paper P.

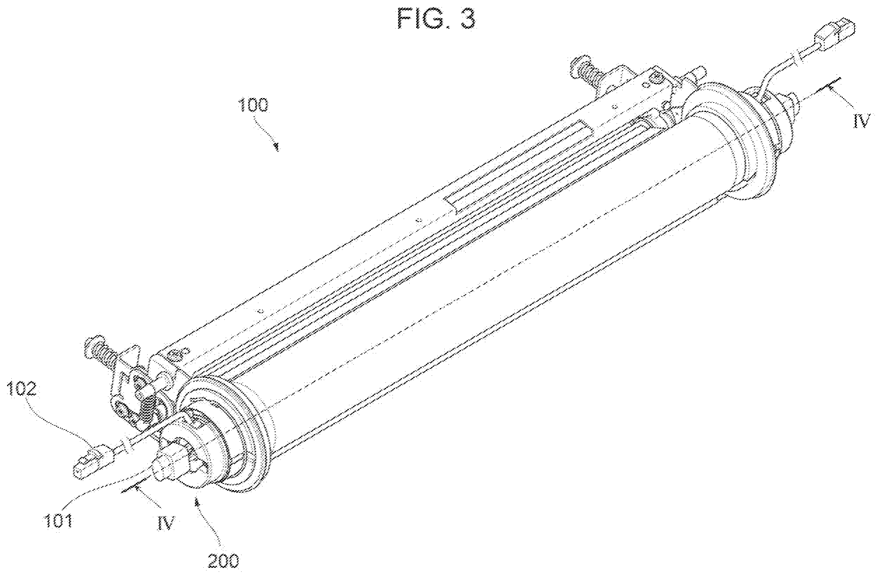

FIG. 3 is a diagram for explaining the resistance heating element 100 according to the exemplary embodiment, and is a perspective view of the resistance heating element 100 of FIG. 2 viewed from III direction. FIG. 3 illustrates a connector 200 that is attached to the resistance heating element 100 and supplies electric power to the resistance heating element 100 through a contact terminal (described later). This connector 200 is configured to supply electric power to an electrode portion (described later) of the resistance heating element 100 so as to heat a heating layer (described later) of the resistance heating element 100.

The resistance heating element 100 includes a heating lamp 101 provided therein to heat the resistance heating element 100, and a harness 102 that delivers electric power to an inner ring (described later) of the connector 200. The heating lamp 101 includes a central portion heating lamp (not illustrated) and an end portion heating lamp (not illustrated). The heating processing is performed in accordance with a paper size by selectively using heating of the heating layer (described later) of the resistance heating element 100 and heating of the heating lamp 101. For example, to heat the paper P of a small size, the heating processing is performed using the central portion heating lamp of the heating lamp 101. For example, to heat the paper P of a large size, the heating processing is performed using heating of the heating layer (described later) by the connector 200 and heating of the outer side of the heating layer (described later) by the end portion heating lamp of the heating lamp 101.

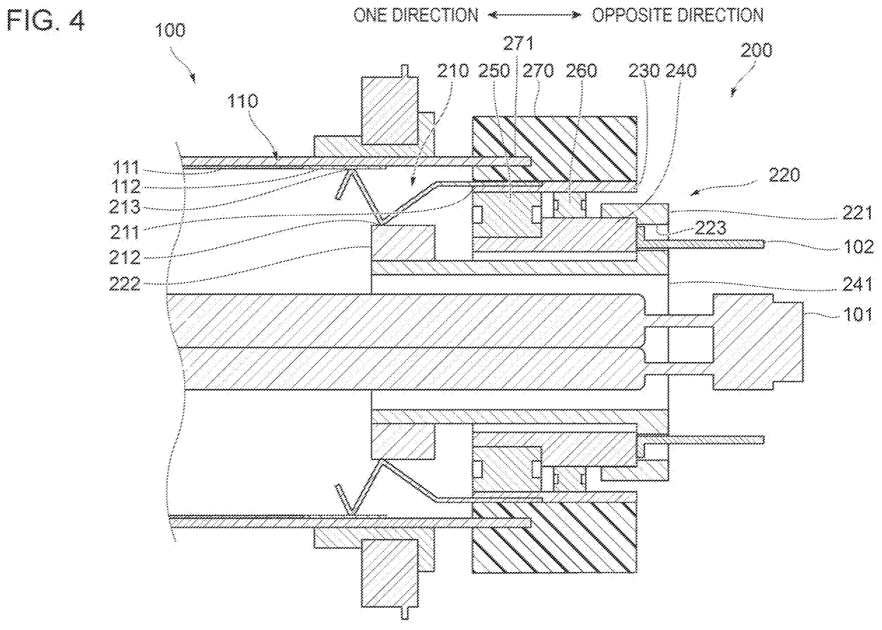

FIG. 4 is a diagram for explaining an electrode portion 110 of the resistance heating element 100 and the connector 200 according to the exemplary embodiment, and is a cross section cut along IV-IV of FIG. 3. FIG. 4 illustrates a state in which the connector 200 is installed in the resistance heating element 100. As illustrated in FIG. 4, the resistance heating element 100 includes the electrode portion 110 to which electric power is supplied from the connector 200. The electrode portion 110 is provided along the inner peripheral surface of the resistance heating element 100. In a case where the resistance heating element 100 is made of a conductive material such as iron or aluminum, for example, the entire inner peripheral surface is covered with an insulator such as polyimide, for example, and the electrode portion 110 is provided on the further inner peripheral surface. The electrode portion 110 includes a heating layer 111 that generates heat by electric resistance, and a current feeding layer 112 that is disposed on an extension line of the heating layer 111 and delivers electric power from the connector 200 to the heating layer 111. The current feeding layer 112 is made of a material having a small electric resistance and easily conducting electricity, such as gold or silver, for example, and prevents heat generation at a portion other than the heating layer 111.

Further, as illustrated in FIG. 4, the connector 200 includes a contact terminal 210 that supplies electric power by contacting the current feeding layer 112 of the electrode portion 110. The contact terminal 210 is formed of a plate-like member and includes a plurality of bent portions. The connector 200 also includes an outer cover 220 that presses the contact terminal 210 against the current feeding layer 112 of the electrode portion 110 of the resistance heating element 100 after the connector 200 is attached to the resistance heating element 100.

Furthermore, the connector 200 includes an outer ring 230, an inner ring 240, a power supply ring 250, a ball bearing 260, and a resin member 270. The cylindrical outer ring 230 is provided on the inner side of the resistance heating element 100 and rotates together with the resistance heating element 100. The cylindrical inner ring 240 is provided on the inner side of the outer ring 230 and does not rotate together with the resistance heating element 100. The power supply ring 250 is provided between the outer ring 230 and the inner ring 240, and delivers electric power from the inner ring 240 to the outer ring 230. The ball bearing 260 is provided between the outer ring 230 and the inner ring 240. The resin member 270 is positioned on the upper side of the outer ring 230, and physically connects the connector 200 and the resistance heating element 100. In the exemplary embodiment, electric power is delivered to the harness 102, the inner ring 240, the power supply ring 250, the outer ring 230, the contact terminal 210, the current feeding layer 112, and the heating layer 111 in this order. Note that the outer cover 220 is an example of a pressing structure, and the outer cover 220 presses the contact terminal 210 so that the contact terminal 210 is in contact with the current feeding layer 112 of the electrode portion 110.

The contact terminal 210 has a spring structure with a fulcrum 211 on the upstream side in one direction in which the outer cover 220 moves, a force point 212 at a specific portion contacting with the outer cover 220, and an action point 213 at a portion contacting with the current feeding layer 112 of the electrode portion 110. Here, the one direction in which the outer cover 220 as a pressing structure moves is a direction from the end portion of the resistance heating element 100 toward the central portion thereof in the axial direction of the rotating resistance heating element 100. With the movement of the outer cover 220 in the one direction, the contact terminal 210 having a spring structure is pressed against the outer cover 220 and deformed. With the movement of the outer cover 220 in the one direction, the action point 213 of the contact terminal 210 is brought into contact with the current feeding layer 112 of the electrode portion 110, whereby the connector 200 and the resistance heating element 100 are electrically connected to each other. Note that, in the example illustrated in FIG. 4, the force point 212 is illustrated to be the vertex of the bent portion of the contact terminal 210, but any portion on the inclined surface formed between the fulcrum 211 and the vertex of the bent portion, for example, may be the force point 212.

A plurality of the contact terminals 210 are provided on the outer peripheral surface of the outer ring 230 at predetermined intervals. The outer ring 230 rotates with the rotation of the resistance heating element 100, and thus the plurality of contact terminals 210 also rotate with the rotation of the resistance heating element 100. Note that the plate-like contact terminal 210 may be rounded in accordance with the diameter of the outer ring 230 to increase the contact area.

The outer cover 220 includes an insertion portion 221 that is inserted between the outer ring 230 and the inner ring 240, and a pressing portion 222 that contacts with the force point 212 of the contact terminal 210 to press the contact terminal 210 against the current feeding layer 112 of the electrode portion 110. A portion of the outer cover 220 where the harness 102 is disposed has a hole 223 for inserting the harness 102 therethrough. The insertion portion 221 is formed in a circumferential shape along the outer peripheral surface of the inner ring 240, with a gap to avoid contact with the outer ring 230 at the time of insertion. The insertion portion 221 is formed such that the outer cover 220 comes into contact with the inner ring 240 when the insertion portion 221 is inserted to a predetermined position. The pressing portion 222 is formed to press the contact terminal 210 against the electrode portion 110 of the resistance heating element 100 with the insertion of the insertion portion 221 to the resistance heating element 100. The pressing portion 222 is formed of a member having low frictional resistance, and keeps smooth and continuous contact with the contact terminal 210 when the contact terminal 210 rotates with the rotation of the resistance heating element 100.

The inner ring 240 has a cavity 241 for inserting the heating lamp 101 through the inside of the inner ring 240. As a result, the resistance heating element 100 can use both the heat generation of the heating layer 111 and the heat generation using the heating lamp 101, which improves the efficiency of heating the resistance heating element 100. For example, if only the heat generation of the heating layer 111 is used at first, the start-up time can be shortened. Note that the heating lamp 101 is located on the inner side of the inner ring 240 and is fixed regardless of the rotation of the resistance heating element 100.

The power supply ring 250 is a conductor and has a bearing structure. The outer ring 230 is formed to rotate with the rotation of the resistance heating element 100 with this bearing structure and the ball bearing 260. The inner ring 240 is formed not to rotate with the rotation of the resistance heating element 100 with this bearing structure and the ball bearing 260. In this manner, the position of the inner ring 240 is fixed regardless of the rotation of the resistance heating element 100.

The resin member 270 has a hole 271 formed along the peripheral surface of the resistance heating element 100. The connector 200 is attached to the resistance heating element 100 by moving the connector 200 in the one direction and inserting the surface of the resistance heating element 100 through the hole 271. On the other hand, to remove the connector 200 from the resistance heating element 100, the connector 200 may be moved in the opposite direction of the one direction.

### Pressing Action by Movement of Outer Cover 220 in One Direction

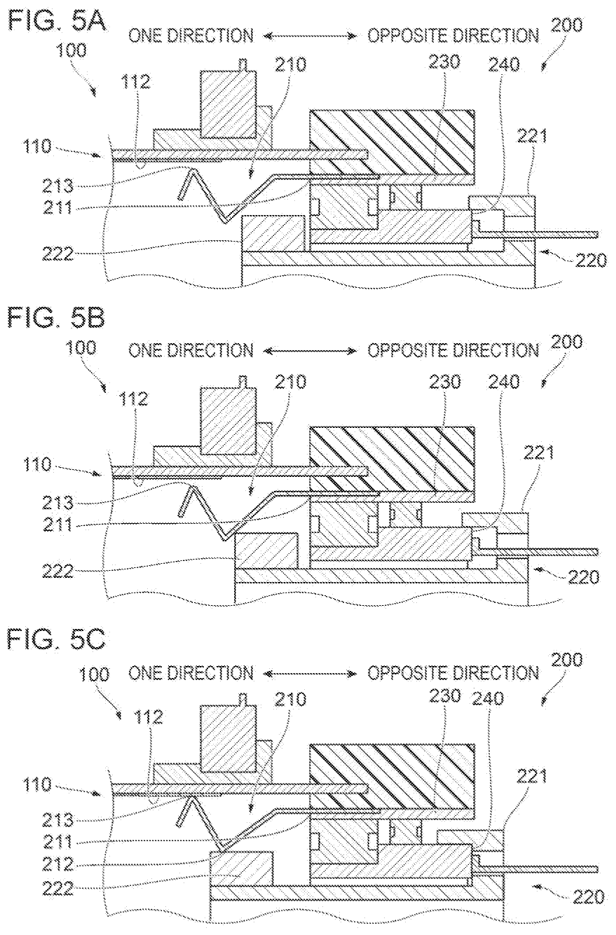

Next, the contact terminal 210 pressing action by moving the outer cover 220 in the one direction will be described with reference to FIGS. 5A to 5C.

FIGS. 5A to 5C are diagrams for explaining the contact of the outer cover 220 with the contact terminal 210 according to the exemplary embodiment, and are diagrams illustrating a cut-out upper part of the resistance heating element 100 in FIG. 4.

FIG. 5A illustrates a state before the outer cover 220 comes into contact with the contact terminal 210. In FIG. 5A, no force is applied on the contact terminal 210 and, the contact terminal 210 is not deformed. The contact terminal 210 is not in contact with the current feeding layer 112 of the electrode portion 110.

FIG. 5B illustrates a state where the pressing portion 222 of the outer cover 220 has come into contact with the contact terminal 210. In this state, the action point 213 of the contact terminal 210 has not been in contact with the current feeding layer 112 of the electrode portion 110. The insertion portion 221 of the outer cover 220 is inserted between the outer ring 230 and the inner ring 240, whereby the outer cover 220 is moved toward the one direction in FIG. 5B, as compared with FIG. 5A Note that in the exemplary embodiment, a direction from the end portion to the central portion in the axial direction of the rotating resistance heating element 100 is adopted as the one direction in which the outer cover 220 moves. However, the one direction may be an oblique direction having an angle in the axial direction.

From the state illustrated in FIG. 5B, the outer cover 220 is further moved in the one direction, whereby the pressing portion 222 of the outer cover 220 further presses and deforms the contact terminal 210. This causes the action point 213 of the contact terminal 210 to gradually approach the current feeding layer 112 of the electrode portion 110. In this series of movements, the outer cover 220 as a pressing structure is moved in the one direction, whereby the action point 213 of the contact terminal 210 is moved in a direction crossing this one direction, and then the contact terminal 210 is pressed against the electrode portion 110.

FIG. 5C illustrates a state in which the outer cover 220 is further moved in the one direction from the state of FIG. 5B to further move the action point 213 of the contact terminal 210 in the crossing direction and, as a result, the action point 213 of the contact terminal 210 comes into contact with the current feeding layer 112 of the electrode portion 110. In FIG. 5C, the outer cover 220 is further moved toward the one direction, as compared with FIG. 5B, and the outer cover 220 is in contact with the inner ring 240. Once the outer cover 220 comes into contact with the inner ring 240, the movement of the outer cover 220 in the one direction is restricted, and the position of the outer cover 220 is fixed. In this state, the pressing portion 222 of the outer cover 220 comes into contact with the force point 212 of the contact terminal 210, and force toward the crossing direction is applied on the contact terminal 210 through the force point 212. Then, the action point 213 of the contact terminal 210 is brought into pressed contact with the current feeding layer 112 of the electrode portion 110, thus ensuring stable conduction.

Note that in FIG. 5C, when the resistance heating element 100 rotates, the contact terminal 210 also rotates together. Even when the contact terminal 210 is rotating, the pressing portion 222, which is a circumferential member and has low frictional resistance, keeps smooth contact. This ensures stable supply of electric power also in the rotating resistance heating element 100.

### Pressing Release Action by Movement of Outer Cover 220 in Opposite Direction

The pressing action by the movement of the outer cover 220 in the one direction has been described above. Next, the pressing release action by moving the outer cover 220 in the opposite direction will be described with reference to FIGS. 5A to 5C. The pressing release action will be described in the order of FIGS. 5C, 5B, and 5A.

For pressing release, a state before the outer cover 220 is moved is a state illustrated in FIG. 5C. Here, the pressing portion 222 of the outer cover 220 is in contact with the force point 212 of the contact terminal 210, and the action point 213 of the contact terminal 210 is in contact with the current feeding layer 112 of the electrode portion 110.

Thereafter, when the outer cover 220 is moved in the opposite direction, the contact between the outer cover 220 and the inner ring 240 is released, and the contact between the pressing portion 222 of the outer cover 220 and the force point 212 of the contact terminal 210 is released, as illustrated in FIG. 5B. Then, the contact between the action point 213 of the contact terminal 210 and the current feeding layer 112 of the electrode portion 110 is released.

When the outer cover 220 is further moved in the opposite direction, the contact between the contact terminal 210 and the outer cover 220 is released, as illustrated in FIG. 5A, so that no external force is applied on the contact terminal 210, and the contact terminal 210 is not deformed. From the state illustrated in FIG. 5A, the connector 200 is further moved in the opposite direction to remove the connector 200 from the resistance heating element 100. With this series of removing operations, the contact terminal 210 does not damage the electrode portion 110.

### Modification

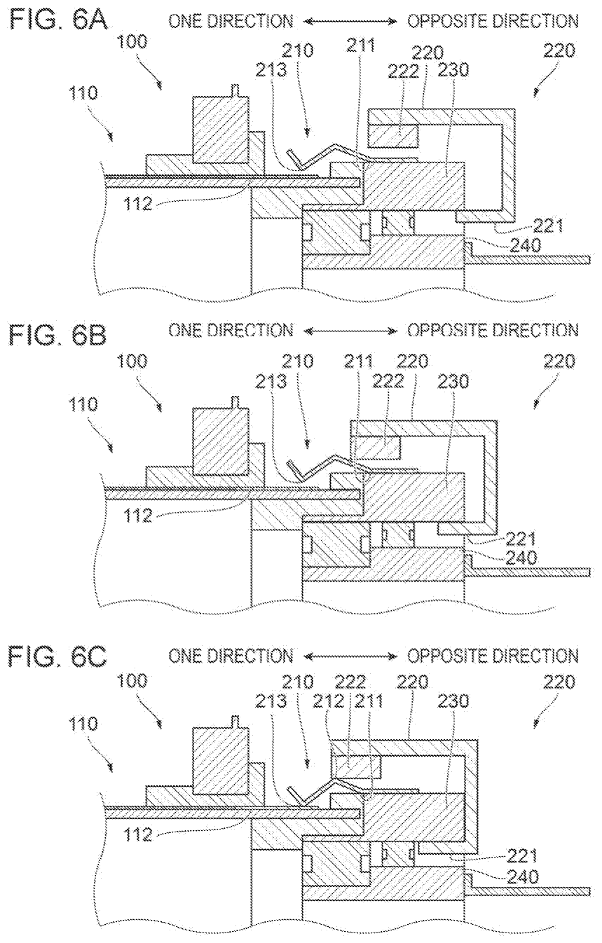

FIGS. 6A to 6C are diagrams illustrating a modification of the connector 200. In FIGS. 5A to 5C, there has been described the case in which the outer cover 220 is moved in the one direction so that the contact terminal 210 is pressed against the current feeding layer 112 of the electrode portion 110 provided on the inner peripheral surface of the resistance heating element 100. Meanwhile, in the modification in FIGS. 6A to 6C, there will be described the case in which the outer cover 220 is moved in the one direction so that the contact terminal 210 is pressed against the current feeding layer 112 of the electrode portion 110 provided on the outer peripheral surface of the resistance heating element 100. Note that the pressing release action by the movement of the outer cover 220 in the opposite direction is also applied to this modification.

In the modification in FIGS. 6A to 6C, the electrode portion 110 of the resistance heating element 100 is disposed on the outer peripheral surface of the resistance heating element 100. The outer cover 220 of the connector 200 is formed to be in contact with the outer ring 230. The insertion portion 221 of the outer cover 220 is formed along the inner peripheral surface of the outer ring 230, with a gap to avoid contact between the insertion portion 221 and the inner ring 240 at the time of insertion.

Next, the contact terminal 210 pressing action by moving the outer cover 220 in the one direction will be described with reference to FIGS. 6A to 6C.

FIG. 6A illustrates a state before the outer cover 220 comes into contact with the contact terminal 210. In FIG. 6A, no force is applied on the contact terminal 210 and, the contact terminal 210 is not deformed. The contact terminal 210 is not in contact with the current feeding layer 112 of the electrode portion 110.

FIG. 6B illustrates a state where the pressing portion 222 of the outer cover 220 has come into contact with the contact terminal 210. In this state, the action point 213 of the contact terminal 210 has not been in contact with the current feeding layer 112 of the electrode portion 110. The insertion portion 221 of the outer cover 220 is inserted between the outer ring 230 and the inner ring 240, whereby the outer cover 220 is moved toward the one direction in FIG. 6B, as compared with FIG. 6A Note that in the exemplary embodiment, a direction from the end portion to the central portion in the axial direction of the rotating resistance heating element 100 is adopted as the one direction in which the outer cover 220 moves. However, the one direction may be an oblique direction having an angle in the axial direction.

From the state illustrated in FIG. 6B, the outer cover 220 is further moved in the one direction, whereby the pressing portion 222 of the outer cover 220 further presses and deforms the contact terminal 210. This causes the action point 213 of the contact terminal 210 to gradually approach the current feeding layer 112 of the electrode portion 110. In this series of movements, the outer cover 220 as a pressing structure is moved in the one direction, whereby the action point 213 of the contact terminal 210 is moved in a direction crossing this one direction, and then the contact terminal 210 is pressed against the electrode portion 110.

FIG. 6C illustrates a state in which the outer cover 220 is further moved in the one direction from the state of FIG. 6B to further move the action point 213 of the contact terminal 210 in the crossing direction and, as a result, the action point 213 of the contact terminal 210 comes into contact with the current feeding layer 112 of the electrode portion 110. In FIG. 6C, the outer cover 220 is further moved toward the one direction, as compared with FIG. 6B, and the outer cover 220 is in contact with the outer ring 230. Once the outer cover 220 comes into contact with the outer ring 230, the movement of the outer cover 220 in the one direction is restricted, and the position of the outer cover 220 is fixed. In this state, the pressing portion 222 of the outer cover 220 comes into contact with the force point 212 of the contact terminal 210, and force toward the crossing direction is applied on the contact terminal 210 through the force point 212. Then, the action point 213 of the contact terminal 210 is brought into pressed contact with the current feeding layer 112 of the electrode portion 110, thus ensuring stable conduction.

Note that in FIG. 6C, when the resistance heating element 100 rotates, the contact terminal 210 and the outer cover 220 also rotate together. This ensures stable supply of electric power also in the rotating resistance heating element 100.

Although the exemplary embodiments have been described above, the present disclosure is not limited to these exemplary embodiments. For example, the outer cover 220 may be moved in the vertical direction to come into contact with the contact terminal 210. Alternatively, the outer cover 220 may press the contact terminal 210 from a state where the contact terminal 210 and the electrode portion 110 are in contact with each other. Further, even after the contact between the outer cover 220 and the contact terminal 210 is released, the contact terminal 210 may be in contact with the electrode portion 110.

### APPENDIX

(((1)))

A heating device comprising:

a resistance heating element that includes an electrode portion to which electric power is supplied and is rotatable;

a connector that is attached to the resistance heating element, includes a contact terminal rotatable together with the resistance heating element, and supplies electric power to the resistance heating element through the contact terminal; and

a pressing structure that presses the contact terminal against the electrode portion after the connector is attached to the resistance heating element.

(((2)))

The heating device according to (((1))), wherein the pressing structure comes into contact with the contact terminal with movement of the pressing structure in one direction and presses the contact terminal against the electrode portion.

(((3)))

The heating device according to (((1))) or (((2))), wherein a specific portion of the contact terminal is provided in a movement path of the pressing structure in the one direction, and comes into contact with the pressing structure by the movement of the pressing structure in the one direction to serve as a force point, and presses the electrode portion through an action point of the contact terminal.

(((4)))

The heating device according to any one of (((1))) to (((3))), wherein the contact terminal is not in contact with the electrode portion before contacting with the pressing structure.

(((5))

The heating device according to any one of (((1))) to (((4))), wherein the pressing structure is moved in the one direction so as to move the contact terminal in a direction crossing the one direction and press the contact terminal against the electrode portion.

(((6)))

The heating device according to any one of (((1))) to (((5))), wherein the one direction for the pressing structure is a same direction as an axial direction of the rotating resistance heating element.

(((7)))

The heating device according to (((1))), wherein the contact terminal is deformed when the pressing structure presses the contact terminal against the electrode portion.

(((8)))

The heating device according to (((7))), wherein the contact terminal is deformed by a spring structure with a fulcrum on an upstream side in the one direction in which the pressing structure moves, a force point at a specific portion contacting with the pressing structure, and an action point at a portion contacting with the electrode portion.

(((9)))

The heating device according to (((1))), wherein the connector includes:

an outer ring that rotates together with the resistance heating element;

an inner ring that does not rotate together with the resistance heating element; and

a power supply ring that is provided between the outer ring and the inner ring and delivers electric power from the inner ring to the outer ring.

(((10)))

The heating device according to (((9))), wherein the pressing structure is pressed into contact with the inner ring of the connector.

(((11)))

The heating device according to (((9))) or (((10))), wherein the pressing structure is pressed into contact with the outer ring of the connector, and rotates with rotation of the outer ring.

(((12)))

The heating device according to any one of (((9))) to (((11))), wherein the inner ring has a cavity for inserting a heating lamp through an inside of the inner ring, the heating lamp heating the resistance heating element.

(((13)))

The heating device according to (((1))), wherein the pressing structure releases pressing of the contact terminal against the electrode portion with movement in an opposite direction of the one direction.

(((14)))

The heating device according to (((13))), wherein the pressing structure releases contact with the contact terminal with the movement in the opposite direction, and releases contact of the contact terminal with the electrode portion by the release of the contact with the contact terminal.

(((15)))

An image forming apparatus comprising:

a developing device that develops an electrostatic latent image on a photoreceptor;

a transfer section that transfers the developed image onto paper;

a resistance heating element that includes an electrode portion to which electric power is supplied and is rotatable;

a connector that is attached to the resistance heating element, includes a contact terminal rotatable together with the resistance heating element, and supplies electric power to the resistance heating element through the contact terminal;

a pressing structure that presses the contact terminal against the electrode portion after the connector is attached to the resistance heating element; and

a fixing device that fixes the transferred developed image on the paper.

What is claimed is:

1. A heating device comprising:
a resistance heating element that includes an electrode portion to which electric power is supplied and is rotatable;
a connector that is attached to the resistance heating element, includes a contact terminal rotatable together with the resistance heating element, and supplies electric power to the resistance heating element through the contact terminal; and
a pressing structure that presses the contact terminal against the electrode portion after the connector is attached to the resistance heating element.

2. The heating device according to claim 1, wherein the pressing structure comes into contact with the contact terminal with movement of the pressing structure in one direction and presses the contact terminal against the electrode portion.

3. The heating device according to claim 2, wherein a specific portion of the contact terminal is provided in a movement path of the pressing structure in the one direction, and comes into contact with the pressing structure by the movement of the pressing structure in the one direction to serve as a force point, and presses the electrode portion through an action point of the contact terminal.

4. The heating device according to claim 2, wherein the contact terminal is not in contact with the electrode portion before contacting with the pressing structure.

5. The heating device according to claim 1, wherein the pressing structure is moved in the one direction so as to move the contact terminal in a direction crossing the one direction and press the contact terminal against the electrode portion.

6. The heating device according to claim 5, wherein the one direction for the pressing structure is a same direction as an axial direction of the rotating resistance heating element.

7. The heating device according to claim 1, wherein the contact terminal is deformed when the pressing structure presses the contact terminal against the electrode portion.

8. The heating device according to claim 7, wherein the contact terminal is deformed by a spring structure with a fulcrum on an upstream side in the one direction in which the pressing structure moves, a force point at a specific portion contacting with the pressing structure, and an action point at a portion contacting with the electrode portion.

9. The heating device according to claim 1, wherein the connector includes:
an outer ring that rotates together with the resistance heating element;
an inner ring that does not rotate together with the resistance heating element; and
a power supply ring that is provided between the outer ring and the inner ring and delivers electric power from the inner ring to the outer ring.

10. The heating device according to claim 9, wherein the pressing structure is pressed into contact with the inner ring of the connector.

11. The heating device according to claim 9, wherein the pressing structure is pressed into contact with the outer ring of the connector, and rotates with rotation of the outer ring.

12. The heating device according to claim 9, wherein the inner ring has a cavity for inserting a heating lamp through an inside of the inner ring, the heating lamp heating the resistance heating element.

13. The heating device according to claim 10, wherein the inner ring has a cavity for inserting a heating lamp through an inside of the inner ring, the heating lamp heating the resistance heating element.

14. The heating device according to claim 11, wherein the inner ring has a cavity for inserting a heating lamp through an inside of the inner ring, the heating lamp heating the resistance heating element.

15. The heating device according to claim 1, wherein the pressing structure releases pressing of the contact terminal against the electrode portion with movement in an opposite direction of the one direction.

16. The heating device according to claim 15, wherein the pressing structure releases contact with the contact terminal with the movement in the opposite direction, and releases contact of the contact terminal with the electrode portion by the release of the contact with the contact terminal.

17. An image forming apparatus comprising:
a developing device that develops an electrostatic latent image on a photoreceptor;
a transfer section that transfers the developed image onto paper;
a resistance heating element that includes an electrode portion to which electric power is supplied and is rotatable;
a connector that is attached to the resistance heating element, includes a contact terminal rotatable together with the resistance heating element, and supplies electric power to the resistance heating element through the contact terminal;
a pressing structure that presses the contact terminal against the electrode portion after the connector is attached to the resistance heating element; and
a fixing device that fixes the transferred developed image on the paper.
